(19) United States
(12) Patent Application Publication
(10) Pub. No.: US 2011/0012494 A1
(43) Pub. Date: Jan. 20, 2011

(54) HEAT DISSIPATING DEVICE HAVING LINEAR HEAT DISSIPATING UNIT AND FANLESS LED LAMP USING THE DEVICE

(75) Inventor: Young Ho Yoo, Goyang-si (KR)

Correspondence Address: LOWE HAUPTMAN HAM & BERNER, LLP, 1700 DIAGONAL ROAD, SUITE 300, ALEXANDRIA, VA, 22314, US

(73) Assignee: FAWOO TECHNOLOGY CO., LTD., Bucheon-si (KR)

(21) Appl. No.: 12/667,449

(22) PCT Filed: Jul. 1, 2008
(86) PCT No.: PCT/KR08/03870

§ 371 Date: Dec. 31, 2009

(30) Foreign Application Priority Data
Jul. 5, 2007 (KR) 10-2007-0067755
Jul. 18, 2007 (KR) 10-2007-0071536
Jul. 18, 2007 (KR) 10-2007-0071537

(51) Int. Cl. H01J 61/52; F28F 7/00

(52) U.S. Cl. 313/46; 165/185

(57) ABSTRACT

A heat dissipating device having a linear heat dissipating unit and a fanless LED lamp using the device are disclosed. The heat dissipating device includes a heat dissipating bracket having a heat absorbing part, and a linear heat dissipating unit which is coupled to the heat dissipating bracket and has a coil shape achieved by the continuous winding of a wire into a spiral shape. The heat dissipating bracket includes an insert hole corresponding to part of the linear heat dissipating unit in such a way as to be in surface contact with the part of the linear heat dissipating unit, and the linear heat dissipating unit protrudes to the outside of the heat absorbing part of the heat dissipating bracket to perform a heat exchange process for dissipating heat through natural convection ventilation. The fanless LED lamp includes the linear heat dissipating unit as a heat dissipating means.

### TECHNICAL FIELD

The present invention relates to a heat dissipating device having a linear heat dissipating unit and a fanless LED lamp using the device, in which the linear heat dissipating unit prevents air from remaining in one place in an environment without a fan and dissipates heat by natural convection ventilation, so that the effective heat dissipating area is remarkably large, thus very efficiently dissipating heat from electronic parts having a large heat generation load, such as lamps or industrial equipment, thereby allowing the installed equipment to be smoothly operated, increasing the life span of the equipment, and which removes a fan from the heat dissipating device, thus preventing noise pollution, and considerably reducing manufacturing costs.

### BACKGROUND ART

Generally, an electronic part, such as a CPU (Central Processing Unit), a thermoelement, a VGA (Video Graphic Array) card, or an LED lamp generates a large quantity of heat during operation. When the electronic part or LED lamp exceeds proper temperature, an operational error may be male, and in addition, the electronic part or lamp may become broken or damaged. A heat dissipating device is essentially mounted to a heat generating part.

The preferable heat dissipating device must have a heat absorbing area which is sufficient to rapidly absorb heat from equipment, and a large heat dissipating area for rapidly dissipating the absorbed heat to the outside. Further, the heat dissipating device needs to be ventilated so as to prevent hot air from remaining in one place, thus smoothly discharging the hot air through the heat dissipating area to the atmosphere.

As shown in FIGS. 22 to 24, a conventional heat dissipating device 100, which is mounted to a variety of electronic parts, includes a heat absorbing part 110 which has the shape of a panel to be in surface contact with an object to be cooled, that is, a heat generating part, and a heat dissipating part 130 which is integrated with the heat absorbing part 110 and dissipates the heat from the heat absorbing part to the outside. The heat dissipating part 130 includes heat dissipating fins 131 which are compactly arranged to increase surface area.

When such a conventional heat dissipating device is in an environment where ventilation is performed, the surface area of the heat dissipating fins 131 serves as an effective heat dissipating area, thus smoothly dissipating heat.

However, in an environment where ventilation is not smoothly performed, the heat dissipating operation is performed owing to a difference between the temperature of the heat dissipating fins 131 and the surrounding temperature. The temperature difference between a lower point 101 contacting the heat absorbing part and an upper point 102 which is the farthest from the heat absorbing part is below 10% and the temperature difference between the heat dissipating fins 131 and gaps 104 between neighboring heat dissipating fins is below 10% (see FIG. 23).

The larger the temperature difference between the heat dissipating fins 131 and the gaps 104 is, the higher the heat exchange efficiency for dissipating heat is. However, according to the prior art, a small difference in temperature between a point 106 of each heat dissipating fin 131 which is near to the heat absorbing part 110 and an upper point 107 which is distant from the heat absorbing part exists, so that the conventional heat dissipating device has a poor heat dissipating function.

This happens because air remains in the gaps 104 between the heat dissipating fins while remaining hot. Among the gaps 104 serving as the surface area of the heat dissipating fins 131, portions 105 other than an outermost portion 109, which is very shallow such that the air lightly touches the portion, substantially have no heat dissipating function (see FIG. 24).

Thus, no matter how the surface area may be increased by the heat dissipating fins 131 and the gaps 104 in the environment which is not ventilated, the effective heat dissipating area is only five sides of each heat dissipating fin including four circumferential sides and the upper side, and part 109 of an inlet of a gap between neighboring heat dissipating fins, so that satisfactory heat dissipating performance is not achieved.

That is, in the conventional heat dissipating device which compactly arranges the heat dissipating fins, space occupied by the heat dissipating fins is large, and the air flow path contacting the heat dissipating fins is small, so that natural convection ventilation is not performed, and thus hot air remains in one place. Therefore, heat dissipating efficiency is low.

Further, since the volume of the heat dissipating fins is large, the costs of materials are wasted and the weight is heavy, thus making it difficult to achieve a light device.

In order to prevent hot air from remaining in one place, according to the prior art, a fan for forcibly blowing the air is essentially required.

However, such a fan causes noise pollution and dust, so that dust is deposited on the surface of each heat dissipating fin, and thus the performance of the heat dissipating device is reduced. Because of the increase in costs of the fan and the number of assembling processes caused by the additional part, manufacturing costs are increased.

Moreover, the heat dissipating function is lost when the fan is out of order, so that the expensive device may become damaged.

The dissipation of heat is very important in an LED lamp using an LED (Light Emitting Diode) as a light source.

The LED is smaller and has a longer life-span than the conventional light source, and directly converts electric energy into light energy, so that consumption of power is small, and energy efficiency is superior. However, unless heat is smoothly dissipated when the LED is turned on, the life-span of the LED is shortened, and luminous intensity is reduced. Thus, it can be concluded that the effective usage of the LED lamp is connected directly with the heat dissipating performance.

As shown in FIGS. 25 and 26, a conventional LED lamp 200 includes a light source unit, a heat dissipating means 230, and a housing 250. The light source unit includes a printed circuit board (PCB) 213 and a plurality of LEDs 211 mounted on the PCB 213. The heat dissipating means 230 is attached to the PCB. The housing accommodates and supports the light source unit and the heat dissipating means. The PCB 213 and a power connection part 251 connected to the power are provided on the housing.

Further, the heat dissipating means 230 includes heat dissipating fins 233 which are radially provided on the housing. The plurality of heat dissipating fins 233 which protrude vertically and gaps 231 between the heat dissipating fins are spaced at regular intervals, thus providing the cylindrical or conical heat dissipating means. Such a construction can exhibit sufficient heat dissipating effect due to the increase in the surface area resulting from the formation of the heat dissipating fins 233, as long as ventilation is smoothly performed.

However, under the environment where natural ventilation is not performed, for example when the lamp is installed in a recess formed in a ceiling, air remains in the gaps 231 between the heat dissipating fins, remaining hot. Thus, among the gaps 231 providing the surface area of the heat dissipating fins 233, portions 231a other than the outermost portion, which is very shallow such that the air lightly touches it, substantially have no heat dissipating function.

Thus, no matter how the surface area may be increased by the heat dissipating fins 233 and the gaps 231 under the environment which is not ventilated, the substantial effective heat dissipating area is not increased.

Further, a base and heat dissipating fins are concentrated on the PCB which is a heat generating source, so that the dissipated heat is mutually irradiated, and thereby heat dissipating efficiency is reduced.

In order to reduce thermal load due to the above heat dissipating problem, according to the prior art, a current which is lower than a rated current flows into the PCB. However, in this case, the brightness of the LED is reduced, so that the number of LEDs must be increased so as to meet a preset luminous intensity. Thereby, electric energy is wasted, and manufacturing costs are increased due to the increase in the number of LEDs.

Thus, according to the prior art, a fan is installed in a heat dissipating means.

However, the life-span of the LED is about 50,000 hours, whereas the life-span of the fan is only about 10,000 hours, so that the life-span of an LED lamp is considerably shortened and noise is generated because of the fan. Thus, it is impossible to use in a building demanding quiet.

Further, since dust is deposited on the surface of the heat dissipating means due to the blowing operation, heat dissipating efficiency is lowered.

Further, when the LED lamp is installed outdoors, water, insects, dust, etc. may enter the lamp through a blowing passage defined in the heat dissipating means, thus impairing the fan. Thus, it is impossible to install the LED lamp outdoors, like streetlamps, so that the area of installing an LED lamp becomes limited to the interior of a building which is insensitive to noise.

### DISCLOSURE OF INVENTION

### Technical Problem

Accordingly, the present invention has been male keeping in mind the above problems occurring in the prior art, and an object of the present invention is to provide a heat dissipating device having a linear heat dissipating unit and a fanless LED lamp using the device, in which the linear heat dissipating unit prevents air from remaining in one place in an environment without a fan and dissipates heat by natural convection ventilation, so that the effective heat dissipating area is remarkably large, thus very efficiently dissipating heat from electronic parts having a large heat generation load, such as lamps or industrial equipment, thereby allowing the installed equipment to be smoothly operated, increasing the life span of the equipment, and which removes a fan from the heat dissipating device, thus preventing noise pollution, and considerably reducing manufacturing costs.

Another object of the present invention is to provide a heat dissipating device having a linear heat dissipating unit and a fanless LED lamp using the device, in which ventilation is performed through natural convection, so that a fan can be removed from the heat dissipating device, thus preventing noise pollution and considerably reducing manufacturing costs.

### Technical Solution

In order to accomplish the above objects, the present invention provides a heat dissipating device having a heat dissipating bracket having a heat absorbing part, and a linear heat dissipating unit which is coupled to the heat dissipating bracket and has a coil shape achieved by the continuous winding of a wire into a spiral shape, wherein the heat dissipating bracket includes an insert hole which corresponds to part of the linear heat dissipating unit in such a way as to be in surface contact with the part of the linear heat dissipating unit, and the linear heat dissipating unit protrudes to an outside of the heat absorbing part of the heat dissipating bracket to perform a heat exchange process for dissipating heat through natural convection ventilation.

Further, in order to accomplish the above objects, the present invention provides a fanless LED lamp having a linear heat dissipating unit, which includes a light source unit having at least one LED (Light Emitting Diode) and an LED mounted PCB, a heat dissipating means attached to the LED mounted PCB to dissipate heat from the light source unit, and a housing connected to the heat dissipating means and having a power connection part, wherein the heat dissipating means includes the linear heat dissipating unit.

### Advantageous Effects

As described above, the heat dissipating device having the linear heat dissipating unit and the fanless LED lamp using the device according to the present invention are advantageous in that the linear heat dissipating unit prevents air from remaining in one place in an environment without a fan and dissipates heat by natural convection ventilation, so that the effective heat dissipating area is remarkably large, thus very efficiently dissipating heat from electronic parts having a large heat generation load, such as lamps or industrial equipment, thereby allowing the installed equipment to be smoothly operated and increasing the life span of the equipment.

Further, the present invention is advantageous in that natural convection ventilation is done, thus removing a fan from the heat dissipating device, thereby preventing noise pollution, and considerably reducing manufacturing costs.

### BRIEF DESCRIPTION OF THE DRAWINGS

FIG. 1 is an exploded perspective view illustrating a heat dissipating device having a linear heat dissipating unit according to an embodiment of the present invention;

FIG. 2 is a perspective view illustrating the assembled state of FIG. 1;

FIG. 3 is a vertical sectional view illustrating the installed state of FIG. 2;

FIG. 4 is a view illustrating the construction according to an embodiment of the present invention;

FIG. 5 is a view illustrating the construction according to an embodiment of the present invention;

FIG. 6 is a view illustrating the construction according to an embodiment of the present invention;

FIG. 7 is a view illustrating the construction according to an embodiment of the present invention;

FIG. 8 is a front view of FIG. 7;

FIG. 9 is a view illustrating the construction according to an embodiment of the present invention;

FIG. 10 is a view illustrating the construction according to an embodiment of the present invention;

FIG. 11 is a view illustrating the construction according to an embodiment of the present invention;

FIG. 12 is a partial exploded sectional view illustrating a fanless LED lamp having a linear heat dissipating unit according to an embodiment of the present invention;

FIG. 13 is a sectional view illustrating the assembled state of FIG. 12;

FIG. 14 is a plan view of FIG. 13

FIG. 15 is a sectional view taken along line D-D of FIG. 12;

FIG. 16 is a plan view illustrating a flange-type dissipater of FIG. 12;

FIG. 17 is a view illustrating the construction according to an embodiment of the present invention;

FIG. 18 is a view illustrating the construction according to an embodiment of the present invention;

FIG. 19 is a sectional view taken along line B-B of FIG. 18;

FIG. 20 is a view illustrating the construction according to an embodiment of the present invention;

FIG. 21 is a sectional view taken along line C-C of FIG. 20;

FIG. 22 is a view illustrating the prior art;

FIG. 23 is a side view of FIG. 22;

FIG. 24 is a plan view of FIGS. 22; and

FIG. 25 is a view illustrating the construction of the prior art; and

FIG. 26 is a bottom view of FIG. 25.

### DESCRIPTION OF REFERENCE CHARACTERS OF IMPORTANT PARTS

1: heat dissipating device having a linear heat dissipating unit according to the present invention

2: fanless LED lamp having a linear heat dissipating unit according to the present invention

10: linear heat dissipating unit

10-1: ring-shaped element 11: heat absorbing part

20: heat dissipating bracket 21: heat absorbing part

23: insert hole

25: heat dissipating fin A: heat dissipating means

33: flange-type dissipater

35: fin-type dissipater 37: ventilation dissipater 50: housing 53: holding groove

60: support member

71: ring-shaped support member

### MODE FOR THE INVENTION

Hereinafter, a heat dissipating device having a linear heat dissipating unit and a fanless LED lamp having the device according to the preferred embodiment of the present invention will be described in detail with reference to the accompanying drawings.

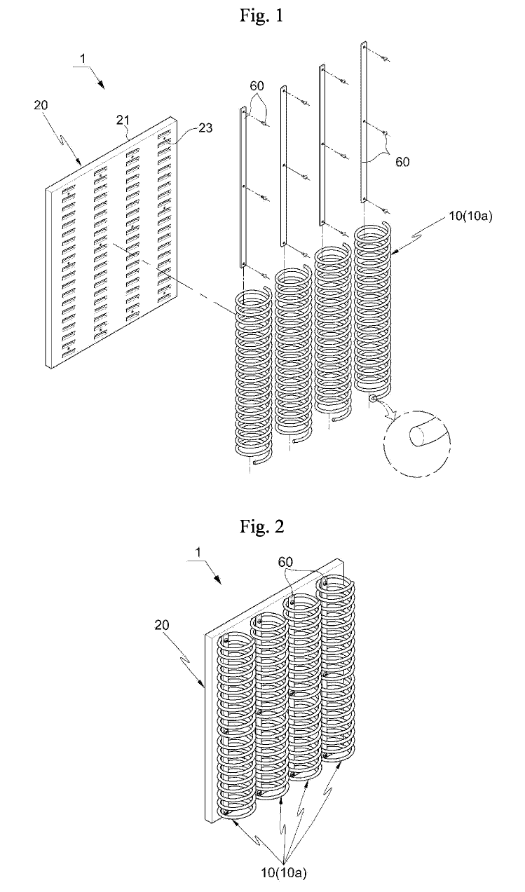

FIG. 1 is an exploded perspective view illustrating a heat dissipating device having a linear heat dissipating unit according to an embodiment of the present invention, and FIG. 2 is a perspective view illustrating the assembled state of FIG. 1.

As shown in FIGS. 1 and 2, a heat dissipating device 1 having a linear heat dissipating unit according to an embodiment of the present invention includes a heat dissipating bracket 20 having a heat absorbing part 21, and linear heat dissipating units 10 which are coupled to the heat dissipating bracket 20 and each have a coil shape male by the continuous winding of a wire into a spiral shape.

The heat dissipating bracket 20 includes insert holes 23 which correspond to part of each linear heat dissipating unit in such a way that the heat dissipating bracket is in surface contact with the part of the linear heat dissipating unit 10. Each linear heat dissipating unit 10 protrudes to the outside of the heat absorbing part 21 of the heat dissipating bracket 20 to perform a heat exchange process for dissipating heat through natural convection ventilation.

Here, the configuration wherein each linear heat dissipating unit 10 protrudes to the outside of the heat absorbing part 21 of the heat dissipating bracket means the configuration of FIGS. 2, 3, and 9. That is, as shown in the drawings, the linear heat dissipating unit 10 protrudes to the outside of the heat absorbing part 21 of the heat dissipating bracket which is in contact with a heat generating unit 5 such that a rising air current of natural convection touches the linear heat dissipating unit. Thereby, ventilation by natural convection is done, and heat is dissipated to the atmosphere.

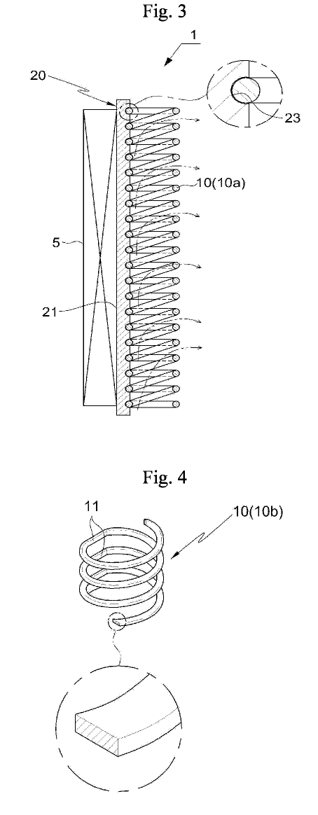

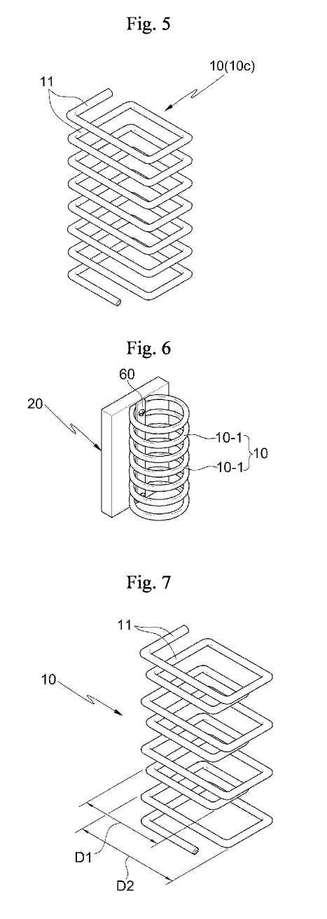

Each linear heat dissipating unit 10 may have a coil spring shape 10a which is formed by winding a wire into a circular shape, a coil spring shape 10b (see FIG. 4) which is also wound into a circular shape but has a linear part on a heat absorbing part 11, or a rectangular coil spring shape 10c (see FIG. 5) which is wound into a rectangular shape. The rectangular coil spring shape 10c is advantageous in that it occupies a smaller space compared to the circularly wound shapes.

The wire used for the linear heat dissipating unit 10 has a circular- or plate-shaped cross-section (see FIGS. 1 and 4).

The linear heat dissipating unit 10 may be male of a material having high thermal conductivity, such as copper or aluminum coil.

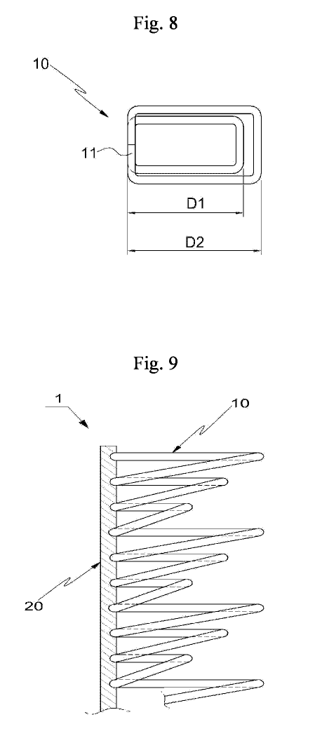

Further, as shown in FIGS. 7 and 8 the linear heat dissipating unit 10 includes standard winding parts D1 which are wound to a standard dimension, and differential winding parts D2 which are smaller than the standard winding parts D1. Preferably, the standard winding parts and the differential winding parts alternate with each other. Such a construction increases the interval between adjacent winding parts, thus increasing heat exchange efficiency.

In order to increase heat absorbing efficiency of the heat absorbing part 11, the standard winding parts D1 and the differential winding parts D2 have the same protruding length to contact with the heat dissipating bracket 20. The winding parts may have three or more dimensions (see FIG. 9).

The linear heat dissipating unit 10 may include a plurality of ring elements 10-1 which are continuously arranged at predetermined intervals (see FIG. 6). Each ring element comprises a circular ring or a polygonal ring which is formed by winding a wire. The ring element 10-1 is welded to the heat dissipating bracket or is mounted to the heat dissipating bracket using a support member 60.

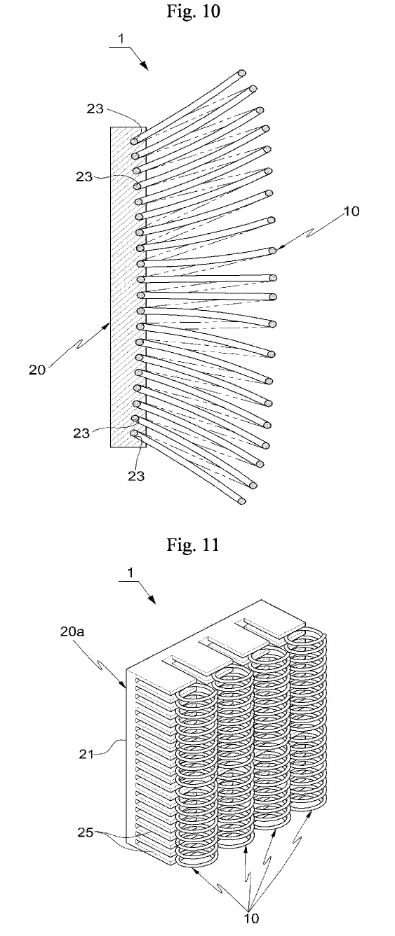

Further, the inclination angles of the insert holes 23, which are in surface contact with a section of the linear heat dissipating unit 10, are increased in a direction distant from a center (see FIG. 10). The insert holes 23 are formed to correspond to the spiral arrangement of the linear heat dissipating unit 10 and the sectional shape of the wire, thus being in surface contact with the linear heat dissipating unit.

Further, as shown in FIG. 11, the heat dissipating bracket 20 comprises a heat dissipating fin bracket 20a on which a plurality of heat dissipating fins 25 is integrally provided. Part of the linear heat dissipating unit 10 may be in surface contact with gaps between the heat dissipating fins 25 to perform a heat exchange process.

The linear heat dissipating bracket 10 may be arranged in a zigzag or spiral shape.

The operation of the heat dissipating device 1 having the linear heat dissipating unit according to the present invention, which is constructed as described above, will be described below.

The linear heat dissipating unit 10 of the present invention, having the coil spring shape, protrudes to the outside of the heat absorbing part of the heat dissipating bracket, so that ventilation space is formed in the rising direction of an air current, that is, in a direction from a lower position to an upper position, so that air does not remain in one place, and ventilation by natural convection is smoothly performed. Thus, even in an environment where a fan is not installed, the heat exchanging operation is smoothly performed by natural convection ventilation, and an effective heat dissipating area as formed is remarkably large.

The surface area of the linear heat dissipating unit 10 is equal to the circumference of the section of the wire multiplied by the length of the coil. When the section of the wire has a circular shape, it is easy to plastically deform the wire into the coil spring shape. Further, the plate shape has higher heat dissipating efficiency than the circular shape.

For example, assuming that the sectional area of the wire is 3.14 mm², the wire having the circular section has the radius r of 1 mm, with the circumference of the wire being 2πr=6.28 mm.

Assuming that the section of the wire has the shape of a thin rectangular plate of 0.5 mm×6.28 mm, the circumference of the rectangular plate is 13.56 mm. Thus, when the rod material has the section of the plate shape, the surface area is remarkably increased.

Further, when calculating the winding circumference and the pitch of the coil, the length of the linear heat dissipating unit 10 is very long.

Thus, the effective heat dissipating area for preventing air from remaining in one place is male to be remarkably large.

Further, when each linear heat dissipating unit 10 is formed such that parts having different winding dimensions are repeated (see FIGS. 7 to 9), the coil is evenly arranged in space. Thus, even if the pitch of the coil is small, heat is more effectively dissipated.

Further, the linear heat dissipating unit 10 is less heavy when compared to the effective heat dissipating area and affords a free change in arrangement, so that it is very easy to handle and hold, and the material used is considerably reduced.

The installation of each linear heat dissipating unit 10 to the heat dissipating bracket 20 will be described now. The linear heat dissipating unit is firmly fitted into the insert holes 23 formed in the heat dissipating bracket, and then secured to the heat dissipating bracket using the support member 60. In this way, the assembly is completed in a simple manner. The linear heat dissipating unit 10 may be welded to the heat dissipating bracket 20.

The operational effects of the present invention will be summarized as follows.

First, the heat dissipating area is maximized owing to the linear heat dissipating unit.

Second, the insert holes 23 are formed in the heat dissipating bracket 20 to increase a contact surface with the linear heat dissipating unit, so that a sufficient heat absorbing area for absorbing heat is ensured.

Third, the linear heat dissipating unit 10 protrudes outside of the heat dissipating bracket 20, so that ventilation and natural convection of rising hot air are smoothly performed, and thus heat exchanging operation for radiating heat to the atmosphere is effectively performed.

That is, due to the insert holes in the heat dissipating bracket, sufficient heat absorbing performance is ensured. Further, the linear heat dissipating unit protrudes to the outside of the heat dissipating bracket to be located in space which is ventilated through natural convection, so that smooth ventilation is possible without a blowing fan. Thereby, the three factors determining the quality of the heat dissipating device are perfectly satisfied.

Thus, the present invention exhibits superior performance as a heat dissipating means for equipment having high heat generation load, such as an electronic part, including a CPU, a thermoelement, or a VGA card, a lamp, and industrial equipment, thus allowing the installed equipment to be smoothly operated, and increasing the life-span of the equipment.

Further, the present invention can omit the fan which is essential for the conventional heat dissipating device, thus preventing noise from being generated, reducing costs of parts and the number of processes required to assemble the parts, therefore reducing manufacturing costs.

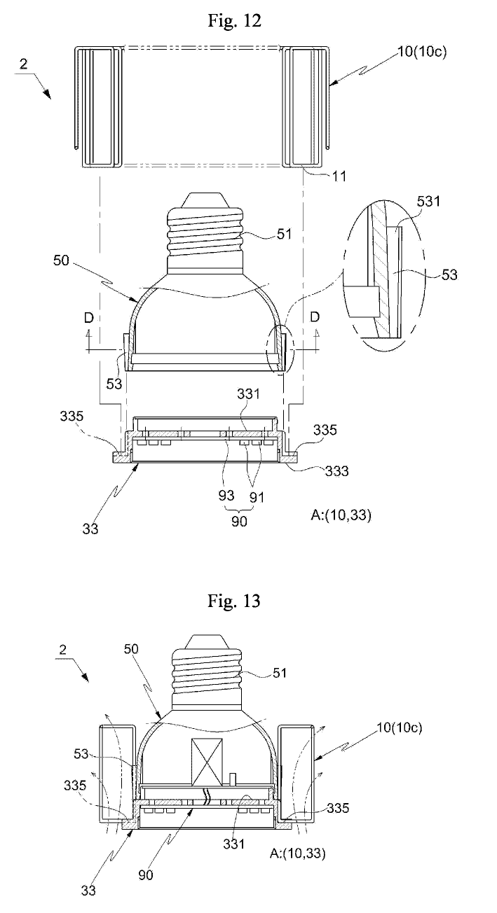

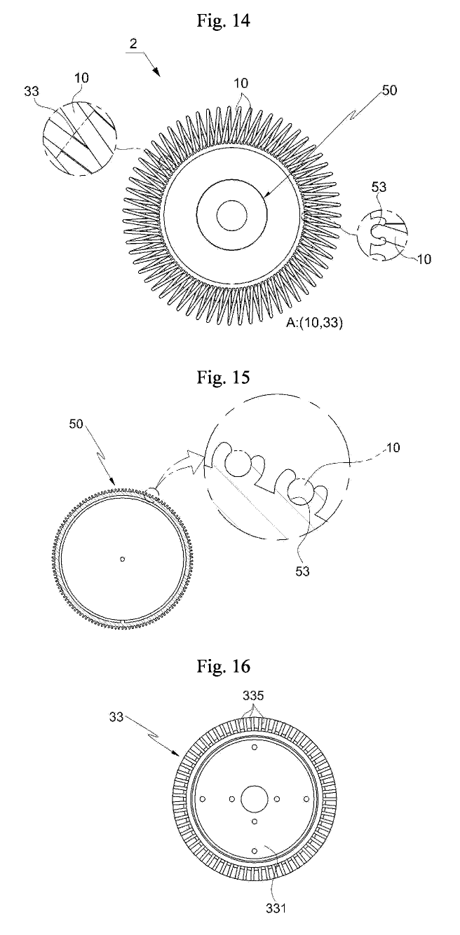

FIG. 12 is a partial exploded sectional view illustrating a fanless LED lamp having a linear heat dissipating unit according to an embodiment of the present invention, FIG. 13 is a sectional view illustrating the assembled state of FIG. 12, FIG. 14 is a plan view of FIG. 13, FIG. 15 is a sectional view taken along line D-D of FIG. 12, and FIG. 16 is a plan view illustrating a flange-type dissipater of FIG. 12.

As shown in FIGS. 12 to 16, a fanless LED lamp 2 having a linear heat dissipating unit according to an embodiment of the present invention includes a light source unit 90 which has one or more LEDs (Light Emitting Diode) 91 and an LED mounted PCB 93, a heat dissipating means A which is attached to the LED mounted PCB 93 to dissipate heat from the light source unit 90, and a housing 50 which is connected to the heat dissipating means A and has a power connection part 51. Here, the heat dissipating means A includes the linear heat dissipating unit 10.

Here, a holding groove 53 having a predetermined pitch is formed in the outer circumference of a dissipater of the heat dissipating means A or the housing 50 to hold the linear heat dissipating unit 10. The linear heat dissipating unit 10 may be arranged in a circular shape along the outer circumference of the dissipater of the heat dissipating means A or the housing 50 using the holding groove 53.

The dissipater of the heat dissipating means A, which has the holding groove 53 in the outer circumference of the dissipater, is a heat dissipating bracket which is provided to contact the LED mounted PCB 93. A flange-type dissipater 33, a fin-type dissipater 35, and a ventilation dissipater 37, which will be described below, belong to the dissipater.

The holding groove 53 may be shaped such that an inlet 531 formed in the upper portion of the holding groove is large and the holding groove is gradually tapered in a direction from an upper position to a lower position, thus affording the easy insertion of the linear heat dissipating unit 10, and preventing the unexpected removal of the linear heat dissipating unit. Preferably, the holding groove has the function of holding the linear heat dissipating unit and is in surface contact with the linear heat dissipating unit.

In order to form the holding groove 53, the thickness of the housing 50 is increased.

According to an embodiment of the present invention, the dissipater of the heat dissipating means A may comprise a flange-type dissipater 33 having a heat absorbing part 331 which contacts the LED mounted PCB 93, and a flange 333 which protrudes outwards from the heat absorbing part 331 and supports part of the linear heat dissipating unit 10.

The flange-type dissipater 33 may include insert holes 335 which are radially formed to correspond to part of the linear heat dissipating unit 10, so that part of the linear heat dissipating unit 10 is in surface contact with the dissipater (see FIGS. 12 and 16).

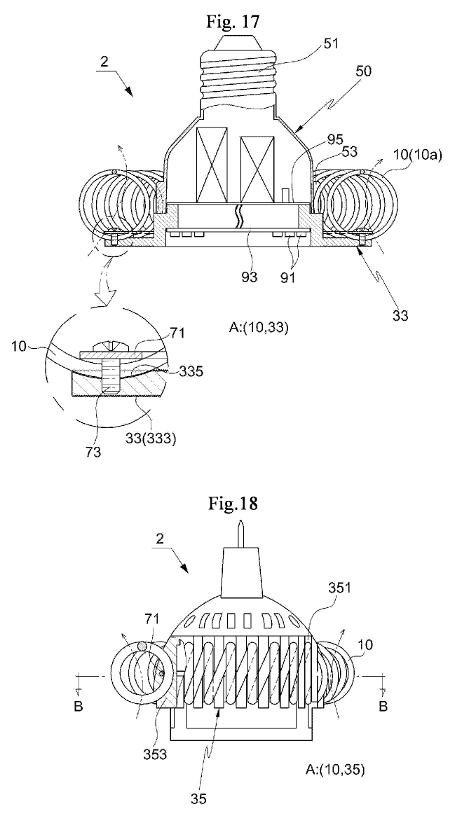

Further, the linear heat dissipating unit 10 also includes a ring-shaped support member 71 which passes through the interior of the linear heat dissipating unit (see FIG. 17).

The support member 71 may be made of a metal material or an elastic material, such as an elastic cord.

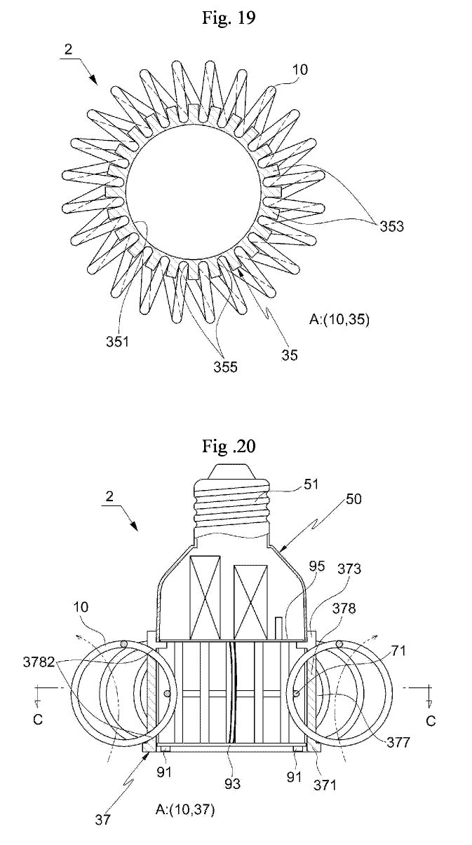

According to an embodiment of the present invention, as shown in FIGS. 18 and 19, the dissipater of the heat dissipating means A may comprise a fin-type dissipater 35 having a plurality of heat dissipating fins 353 protruding from the circumference of a cylindrical body 351 which contacts the LED mounted PCB 93. Part of the linear heat dissipating unit 10 is inserted into gaps 355 of the heat dissipating fins 353 in such a way as to be in surface contact therewith, thus performing a heat exchange process.

The fin-type dissipater 35 is similar to a conventional dissipater except that inside portions of the gaps 355 of the heat dissipating fins are in surface contact with the linear heat dissipating unit 10.

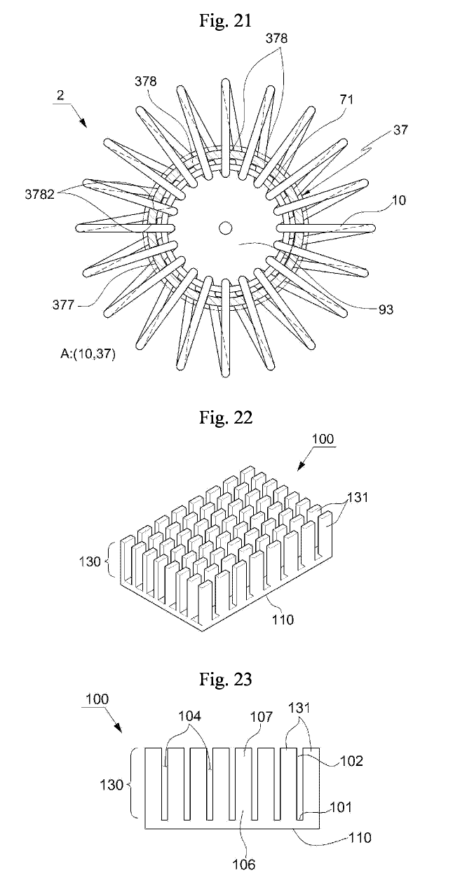

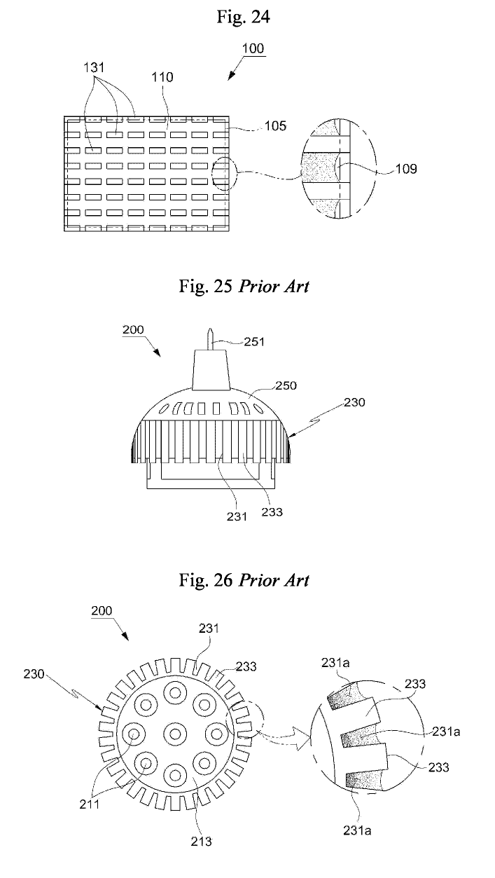

According to an embodiment of the present invention, as shown in FIGS. 20 and 21, the dissipater of the heat dissipating means A may comprise a ventilation dissipater 37 including a base 371 which contacts the LED mounted PCB 93, a top part 373 which contacts a power supply unit PCB 95, and slots 378 which are radially formed at predetermined intervals in a main wall 377 and are narrow and long. The main wall has a predetermined height and connects the base 371 with the top part 373.

The ventilation dissipater 37 is mainly used for a high output LED lamp, and is constructed so that the LED mounted PCB 93 and the power supply unit PCB 95 are spaced apart from each other, thus allowing air to circulate between the LED mounted PCB and the power supply unit PCB. The linear heat dissipating unit 10 is connected to the ventilation dissipater using slots 378.

Upper and lower ends 3782 of the slots are formed to correspond to the shape of the wound liner heat dissipating unit 10, so that the slots 378 are in surface contact with a heat dissipating coil.

The installation and operation of the fanless LED lamp 2 having the linear heat dissipating unit according to the present invention, constructed as described above, will be described below.

When the linear heat dissipating unit 10 is installed at the LED lamp, the linear heat dissipating unit may be directly mounted to the LED mounted PCB 93. However, as described above, preferably, the linear heat dissipating unit is installed to the dissipater of the heat dissipating means A, such as the flange-type dissipater 33, the fin-type dissipater 35, or the ventilation dissipater 37, contacting the LED mounted PCB 93, in such a way as to be in surface contact with the dissipater.

When the linear heat dissipating unit 10 is fitted into the holding groove 53 formed in the housing and is lightly pushed, the lower end of the linear heat dissipating unit, that is, the heat absorbing part 11 is firmly fitted into the insert holes 335 of the flange-type dissipater, so that the assembly is completed in a simple manner. The undesirable removal of the linear heat dissipating unit is prevented by the holding groove 53.

Further, in the case of using the additional support member 71, the support member 71 is put into the heat dissipating coil. In such a state, in the case of the flange-type dissipater 33, part of the linear heat dissipating unit 10 is placed in the insert holes 335, and the support member 71 is fastened in the ring shape and is fastened to the flange-type dissipater 33 using fastening members 73 (see FIG. 17).

Further, in the fin-type dissipater 35 or the ventilation dissipater 37, firm fastening operation is possible only by the support member 71.

According to the present invention, the linear heat dissipating unit 10 is provided on the LED lamp, thus preventing air from remaining in one place, and dissipating heat through natural convection ventilation, therefore allowing the high output LED lamp having a large heat generation load to smoothly dissipate heat generated when the LED is turned on, without using a fan.

Hereinbefore, the preferred embodiments of the present invention have been described with reference to the accompanying drawings. Here, the terminologies or words used in the description and the claims of the present invention should not be interpreted as being limited merely to common and dictionary meanings, but should be interpreted based on the meanings and concepts of the invention in keeping with the scope of the invention. Therefore, although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a heat dissipating device having a linear heat dissipating unit and a fanless LED lamp using the device, in which the linear heat dissipating unit is provided so that natural convection ventilation is done in an environment without a fan, thus preventing air from remaining in one place, and the effective heat dissipating area is remarkably large, thus very efficiently dissipating heat from electronic parts having a large heat generation load, such as lamps or industrial equipment, thereby allowing the installed equipment to be smoothly operated and increasing the life span of the equipment.

Further, according to the present invention, natural convection ventilation is smoothly done, thus removing a fan from the heat dissipating device, thereby preventing noise pollution, and reducing manufacturing costs.

1. A heat dissipating device having a heat dissipating bracket having a heat absorbing part, and a linear heat dissipating unit which is coupled to the heat dissipating bracket and has a coil shape achieved by the continuous winding of a wire into a spiral shape, wherein
the heat dissipating bracket comprises an insert hole which corresponds to part of the linear heat dissipating unit in such a way as to be in surface contact with the part of the linear heat dissipating unit, and
the linear heat dissipating unit protrudes to an outside of the heat absorbing part of the heat dissipating bracket to perform a heat exchange process for dissipating heat through natural convection ventilation.

2. The heat dissipating device according to claim 1, wherein the linear heat dissipating unit comprises a coil spring shape which is formed by winding a wire continuously in a circular shape, a coil spring shape which is wound in a circular shape but has a linear part on a heat absorbing part, or a rectangular coil spring shape which is wound into a rectangular shape.

3. The heat dissipating device according to claim 1, wherein the wire for the linear heat dissipating unit has a circular or plate-shaped cross-section.

4. The heat dissipating device according to claim 1, wherein the linear heat dissipating unit comprises a standard winding part which is wound to have a standard dimension, and a differential winding part which is smaller than the standard winding part, the standard winding part and the differential winding part alternating with each other.

5. The heat dissipating device according to claim 1, wherein the linear heat dissipating unit comprises a plurality of ring elements which are continuously arranged at predetermined intervals, each ring element comprising a circular ring or a polygonal ring formed by winding a wire.

6. The heat dissipating device according to claim 1, wherein an inclination angle of the insert hole, which is in surface contact with part of the linear heat dissipating unit, is increased in a direction distant from a center of the heat dissipating bracket.

7. The heat dissipating device according to claim 1, wherein the heat dissipating bracket comprises a heat dissipating fin bracket on which a plurality of heat dissipating fins is integrally provided, and part of the linear heat dissipating unit is in surface contact with gaps between the heat dissipating fins to perform a heat exchange process.

8. A fanless LED lamp having a linear heat dissipating unit, including a light source unit having at least one LED (Light Emitting Diode) and an LED mounted PCB, heat dissipating means attached to the LED mounted PCB to dissipate heat from the light source unit, and a housing connected to the heat dissipating means and having a power connection part, wherein
the heat dissipating means comprises the linear heat dissipating unit described in claim 1.

9. The fanless LED lamp having the linear heat dissipating unit according to claim 8, wherein
a holding groove having a predetermined pitch is formed in an outer circumference of a dissipater of the heat dissipating means or the housing to hold the linear heat dissipating unit, and
the linear heat dissipating unit is arranged in a circular shape along the outer circumference of the dissipater of the heat dissipating means or the housing using the holding groove.

10. The fanless LED lamp having the linear heat dissipating unit according to claim 9, wherein
the dissipater of the heat dissipating means comprises a flange-type dissipater having a heat absorbing part which contacts the LED mounted PCB, and a flange which protrudes outwards from the heat absorbing part and supports part of the linear heat dissipating unit.

11. The fanless LED lamp having the linear heat dissipating unit according to claim 9, wherein
the dissipater of the heat dissipating means comprises a fin-type dissipater having a plurality of heat dissipating fins protruding from a circumference of a cylindrical body which contacts the LED mounted PCB, and
part of the linear heat dissipating unit is inserted into gaps of the heat dissipating fin in such a way as to be in surface contact therewith, thus performing a heat exchange process.

12. The fanless LED lamp having the linear heat dissipating unit according to claim 9, wherein
the dissipater of the heat dissipating means comprises a ventilation dissipater including a base which contacts the LED mounted PCB, a top part which contacts a power supply unit PCB, and slots which are radially formed at predetermined intervals in a main wall and are narrow and long, the main wall having a predetermined height and connecting the base with the top part.

13. The fanless LED lamp having the linear heat dissipating unit according to claim 9, wherein
the linear heat dissipating unit further comprises a support member which passes through the linear heat dissipating unit and is fastened in a ring shape.
